(19) United States
(12) Patent Application Publication
(10) Pub. No.: US 2013/0240733 A1
(43) Pub. Date: Sep. 19, 2013

(54) MODULAR MULTI-USE THERMAL IMAGING SYSTEM

(71) Applicant: Vadim Plotsker, Amherst, NH (US)

(72) Inventor: Vadim Plotsker, Amherst, NH (US)

(73) Assignee: BAE Systems Information and Electronic Systems Integration Inc., Nashua, NH (US)

(21) Appl. No.: 13/885,818

(22) PCT Filed: Aug. 24, 2012
(86) PCT No.: PCT/US12/52181

§ 371 Date: May 16, 2013

Related U.S. Application Data
(60) Provisional application No. 61/527,240, filed on Aug. 25, 2011.

(51) Int. Cl. G01J 5/04; F41G 1/32

(52) U.S. Cl. CPC G01J 5/04; F41G 1/32
USPC 250/338.1; 42/111

(57) ABSTRACT

A modular multi-use thermal imaging system is disclosed. In one embodiment, the modular multi-user thermal imaging system includes a modular mounting structure and a modular multi-use thermal imaging device configured to attach to one or more structures via the modular mounting structure.

### CROSS-REFERENCE TO RELATED APPLICATIONS

This Application claims rights under 35 USC §119(e) from U.S. Application 61/527,240 filed Aug. 25, 2011, the contents of which are incorporated herein by Reference.

### BACKGROUND OF THE INVENTION

1. Field of the Invention

The present invention relates to thermal imaging devices and more particularly to modular multi-use clip-on thermal imaging systems.

2. Brief Description of Related Art

Existing thermal imaging devices utilize attachments to night vision goggles and the like. These thermal imaging devices including the attachments may be limited when a soldier, law enforcement officer, or other night vision user needs to switch to use a weapon or other such devices. Further, due to limited display apertures that are customized for night vision goggle front inject such thermal imaging devices may not be easily transferred between applications.

### SUMMARY OF THE INVENTION

A modular multi-use thermal imaging system is disclosed. According to one aspect of the present subject matter, the modular multi-user thermal imaging system includes a modular mounting structure and a modular multi-use thermal imaging device configured to attach to one or more structures via the modular mounting Structure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates an example modular multi-use thermal imaging system including a modular multi-use thermal imaging device along with a suitable modular mounting structure for the modular multi-use thermal imaging device;

FIGS. 2A and 2B illustrate example modular mounting structures for use with the modular multi-use thermal imaging device such as the one shown in FIG. 1;

FIG. 3 illustrates example views of the modular multi-use thermal imaging device, such as the one shown in FIG. 1, mounted on a weapon;

FIG. 4 illustrates example images including scales and cross hairs obtained from the modular multi-use thermal imaging device, such as the one shown in FIG. 1;

FIG. 5 illustrates another example modular multi-use thermal imaging device including a near infrared laser pointer device;

FIG. 6 illustrates various example lens assemblies that are suitable for use with the modular multi-use thermal imaging device, such as those shown in FIGS. 1 and 5;

FIGS. 7A and 7B illustrate example schematic views of the modular multi-use thermal imaging device, such as those shown in FIGS. 1 and 5, attached to other optical devices using a multiple-device mount; and

FIG. 8 shows the modular multi-use thermal imaging device, such as those shown in FIGS. 1 and 5, attached to the bottom of a helmet mount, according to an embodiment of the present subject matter.

### DETAILED DESCRIPTION OF THE INVENTION

The exemplary embodiments described herein in detail for illustrative purposes are subject to many variations in structure and design.

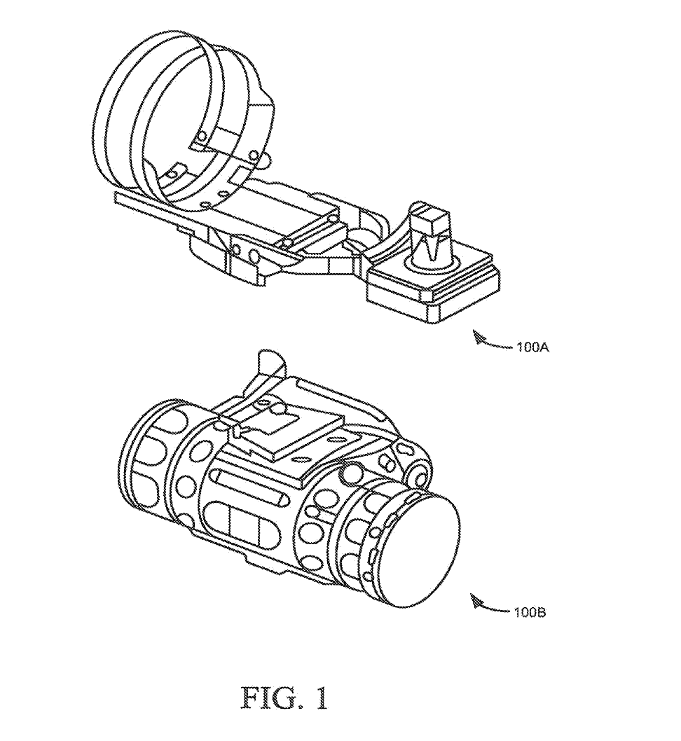

FIG. 1 illustrates an example modular multi-use thermal imaging system including a modular multi-use thermal imaging device 100B along with a suitable modular mounting structure 100A for the modular multi-use thermal imaging device 100B. The modular multi-use thermal imaging system employs a large aperture modular design that utilizes a parasitic clip on thermal imager approach. The modular multi-use thermal imaging system also functions as a separate piece that is configured to receive power and commands from a main thermal module. The modular multi-use thermal imaging system can be deployed for reconnaissance, surveillance, and targeting in all lighting conditions, including total darkness and times when vision is obstructed due to battlefield obscurants such as smoke, fog, sand storms, etc.

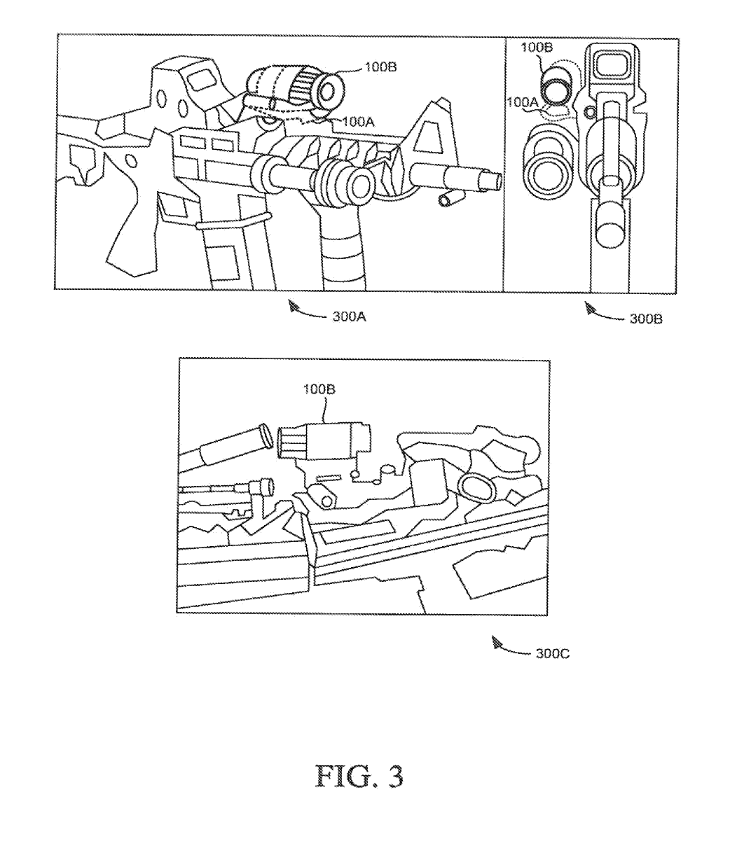

In one embodiment, the modular multi-use thermal imaging device 100B is configured to attach to one or more structures via the modular mounting structure 100A. Exemplary structures include a rifle, an optical device, and a helmet. This is explained in more detail with reference to FIGS. 3, 7A, 7B and 8. For example, the modular multi-use thermal imaging device 100B is configured to attach to the one or more structures via the modular mounting structure 100B with a clip-on connection. The modular multi-use thermal imaging device 100B is also configured to be operated independently as a hand-held device.

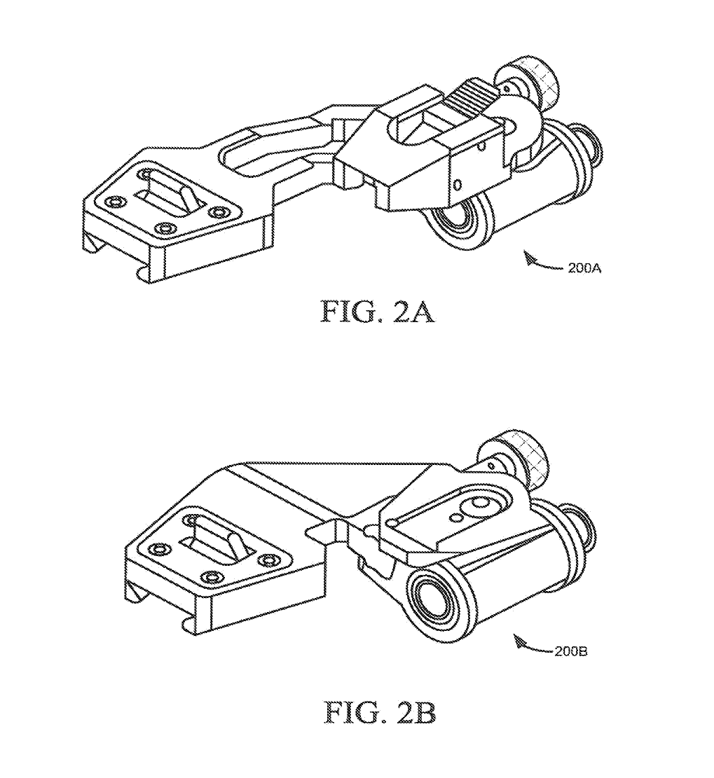

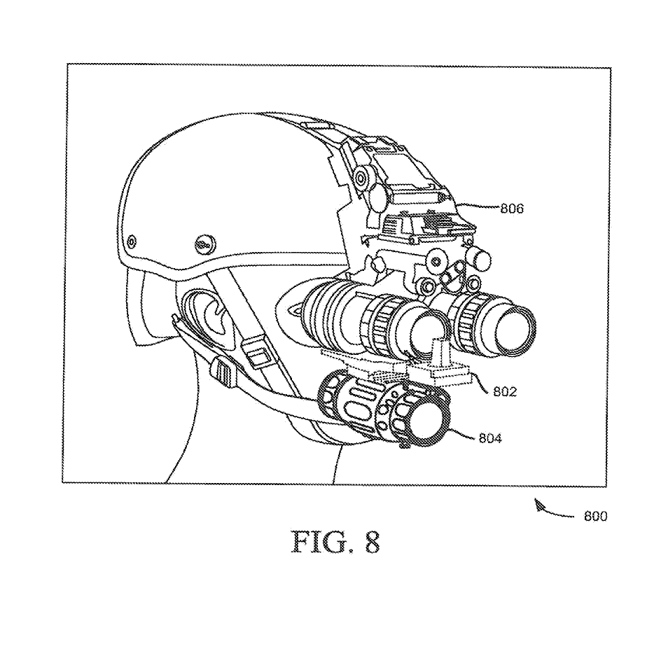

Referring now to FIGS. 2A and 2B, which illustrates example modular mounting structures 200A and 200B for use with the modular multi-use thermal imaging device 100B, such as the one shown in FIG. 1. The modular mounting structures 200A and 200B are used to attach the modular multi-use thermal imaging device 100B on a bottom of a helmet mount. This is explained in more detail with reference to FIG. 8. Further, the modular multi-use thermal imaging device 100B is easily removed from the helmet mount. The modular mounting structures 200A and 200B is also compatible with a rifle mounting rail. This is explained in more detail with reference to FIG. 3.

Referring now to FIG. 3, which illustrates example views of the modular multi-use thermal imaging device 100B, such as the one shown in FIG. 1, mounted on a weapon. Particularly, FIG. 3 illustrates side views 300A and 300C and front view 300B of the modular multi-use thermal imaging device 100B mounted on the weapon. As shown, the modular multi-use thermal imaging device 100B is mounted on the weapon using the modular mounting structure 100A, shown in FIG. 1. The modular multi-use thermal imaging device 100B is easily connected and discontented from the weapon. Further, the modular mounting structure 100A allows the modular multi-use thermal imaging device 100B to be pivoted out of the optical line of sight. For example, the modular multi-use thermal imaging device 100B is suitable for M249SAW and M240 top rail with daytime optics.

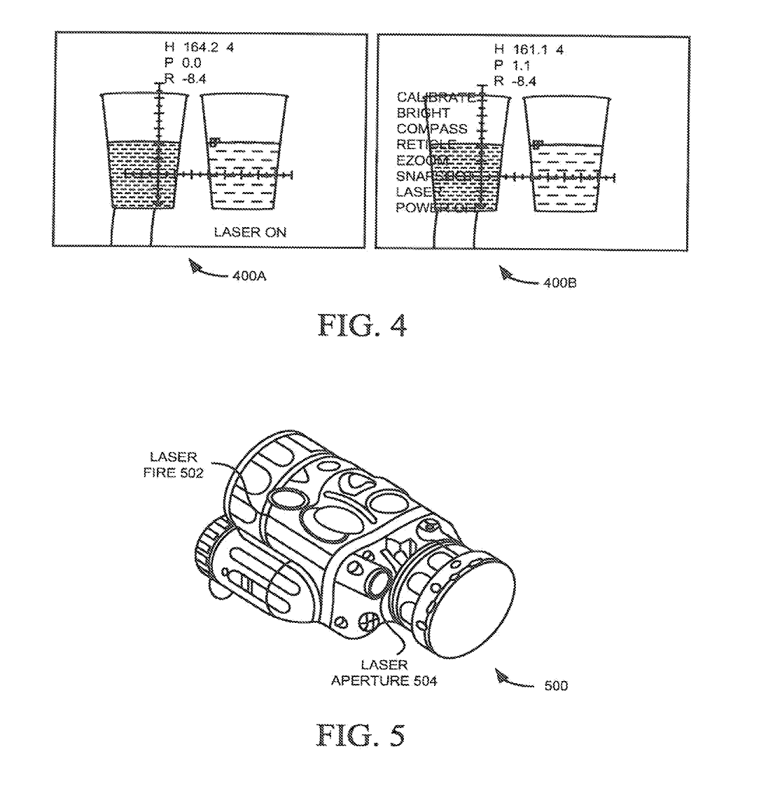

Referring now to FIG. 4, which illustrates example images including scales and cross hairs obtained from the modular multi-use thermal imaging device 100B, such as the one shown in FIG. 1. In one embodiment, the modular multi-use thermal imaging device 100B is incorporated with a user selectable cross-hair or horizontal and vertical scales. The modular multi-use thermal imaging device 100B also includes a tilt compensated compass. Further, pitch and roll is also displayed.

Referring now to FIG. 5, which illustrates another example modular multi-use thermal imaging device 500 including a near infrared laser pointer device. Particularly, FIG. 5 illustrates the modular multi-use thermal imaging device 500 including a laser fire 502 and a laser aperture 504. In one embodiment, a near infrared laser pointer is integrated on the front of the modular multi-use thermal imaging device 500 and is used to highlight targets of interest for other image-intensifier (I²) equipped operators.

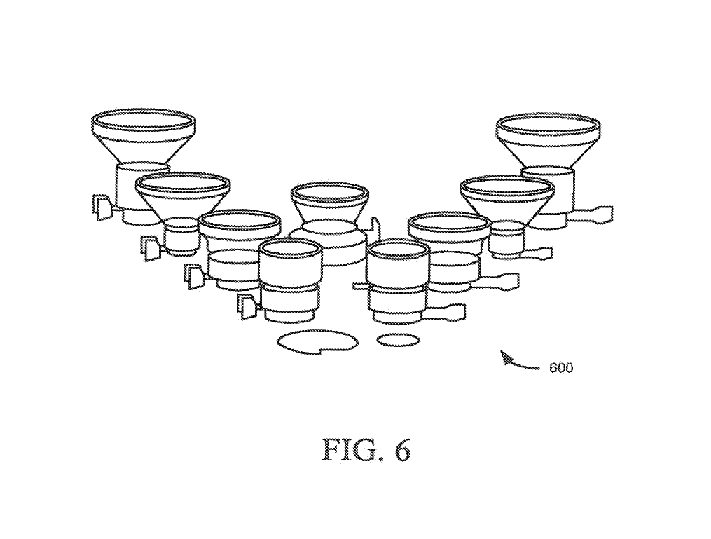

Referring now to FIG. 6, which illustrates various example lens assemblies that are suitable for use with the modular multi-use thermal imaging devices 100B and 500, such as those shown in FIGS. 1 and 5, respectively. The modular multi-use thermal imaging devices 100B and 500 are easily installed in the field with lenses for longer range or wide area surveillance without the use of tools or loss of system environmental integrity. The modular multi-use thermal imaging devices 100B and 500 are also configured to retrofit to connect with existing optical lenses.

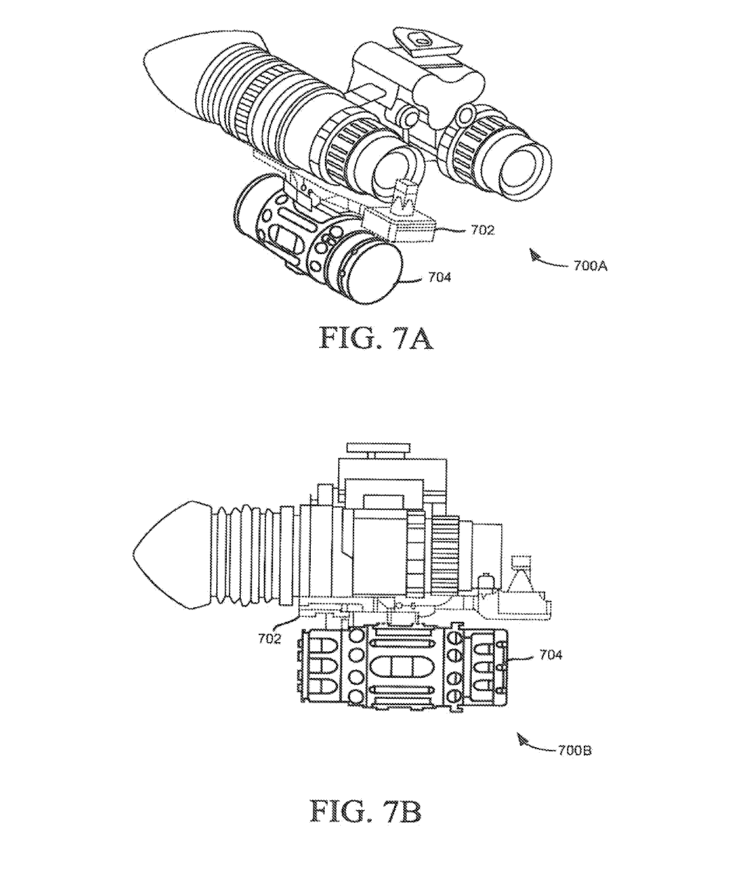

Referring now to FIGS. 7A and 7B, which illustrate example schematic views of a modular multi-use thermal imaging device 704 attached to other optical devices using a multiple-device mount 702. Particularly, FIG. 7A illustrates an isometric view 700A of the modular multi-use thermal imaging device 704 attached to other optical devices and FIG. 7B illustrates a side view 700B of the modular multi-use thermal imaging device 704 attached to other optical devices. The modular multi-use thermal imaging device 704 is any one of the modular multi-use thermal imaging devices 100B and 500, shown in FIGS. 1 and 5, respectively. In one embodiment, the modular multi-use thermal imaging device 704 is compatible with one or more optical devices and is easily attached and detached from the optical devices.

Referring now to FIG. 8, which shows a modular multi-use thermal imaging device 704 attached to the bottom of a helmet mount 806, according to an embodiment of the present subject matter. The modular multi-use thermal imaging device 804 is any one of the modular multi-use thermal imaging devices 100B and 500, shown in FIGS. 1 and 5, respectively. Further, the modular multi-use thermal imaging device 804 is attached to the helmet mount 806 using modular mounting device 802. The modular mounting device 802 is any one of the modular mounting devices 100A, 200A and 200B, shown in FIGS. 1 and 2.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A modular multi-user thermal imaging system, comprising:
a modular mounting structure; and
a modular multi-use thermal imaging device configured to attach to one or more structures via the modular mounting structure.

2. The modular multi-user thermal imaging system of claim 1, wherein the modular multi-use thermal imaging device is configured to attach to the one or more structures via the modular mounting structure with a clip-on connection.

3. The modular multi-user thermal imaging system of claim 1, wherein the modular multi-use thermal imaging device is configured to be operated independently as a hand-held device.

4. The modular multi-user thermal imaging system of claim 1, wherein the one of the one or more structures is selected from the group consisting of a rifle, an optical device, and a helmet.

5. The modular multi-user thermal imaging system of claim 1, wherein the modular mounting structure is compatible with a rifle mounting rail.

6. The modular multi-user thermal imaging system of claim 1, wherein the modular mounting structure is compatible with a bottom of a helmet mount.

7. The modular multi-user thermal imaging system of claim 1, wherein the modular mounting structure is compatible with one or more optical devices.

8. The modular multi-user thermal imaging system of claim 1, wherein the modular mounting structure allows the modular multi-use thermal imaging device to be pivoted out of the optical line of sight.

9. The modular multi-user thermal imaging system of claim 1, wherein the modular multi-use thermal imaging device is configured to retrofit to connect with existing optical lenses.

10. The modular multi-user thermal imaging system of claim 1, wherein the modular multi-use thermal imaging device comprises a near infrared laser pointing device.

11. The modular multi-user thermal imaging system of claim 1, wherein the modular multi-use thermal imaging device comprises a tilt compensated compass.

12. A modular multi-user thermal imaging system, comprising:
a modular mounting structure; and
a modular multi-use thermal imaging device configured to attach to one or more structures via the modular mounting structure, wherein the modular multi-use thermal imaging device is configured to attach to the one or more structures via the modular mounting structure with a clip-on connection, and further configured to be operated independently as a hand-held device.

13. The modular multi-user thermal imaging system of claim 12, wherein the one of the one or more structures is selected from the group consisting of a rifle, an optical device, and a helmet.

14. The modular multi-user thermal imaging system of claim 12, wherein the modular mounting structure is compatible with a rifle mounting rail.

15. The modular multi-user thermal imaging system of claim 12, wherein the modular mounting structure is compatible with a bottom of a helmet mount.

16. A modular multi-user thermal imaging system, comprising:
a modular mounting structure; and
a modular multi-use thermal imaging device configured to attach to one or more structures via the modular mounting structure, wherein the modular multi-use thermal imaging device is configured to attach to the one or more structures via the modular mounting structure with a clip-on connection, and further configured to be operated independently as a hand-held device, wherein the one of the one or more structures is selected from the group consisting of a rifle, an optical device, and a helmet and wherein the modular mounting structure is compatible with a rifle mounting rail.

17. The modular multi-user thermal imaging system of claim 16, wherein the modular mounting structure is compatible with a bottom of a helmet mount.

18. The modular multi-user thermal imaging system of claim 16, wherein the modular mounting structure is compatible with one or more optical devices.

19. The modular multi-user thermal imaging system of claim 16, wherein the modular mounting structure allows the modular multi-use thermal imaging device to be pivoted out of the optical line of sight.

20. The modular multi-user thermal imaging system of claim 16, wherein the modular multi-use thermal imaging device is configured to retrofit to connect with existing optical lenses.

21. The modular multi-user thermal imaging system of claim 16, wherein the modular multi-use thermal imaging device comprises a near infrared laser pointing device.

22. The modular multi-user thermal imaging system of claim 16, wherein the modular multi-use thermal imaging device comprises a tilt compensated compass.
